(19) United States
(12) Patent Application Publication
(10) Pub. No.: US 2011/0126654 A1
(43) Pub. Date: Jun. 2, 2011

(54) BEVEL AND HYPOID GEAR AND METHOD OF MANUFACTURE

(75) Inventors: Leonid C. Lev, West Bloomfield, MI (US); Leonid B. Aksenov, Sankt-Peterburg (RU); Vladimir N. Vostrov, Sankt-Peterburg (RU)

(73) Assignee: GM GLOBAL TECHNOLOGY OPERATIONS, INC., Detroit, MI (US)

(21) Appl. No.: 12/629,509

(22) Filed: Dec. 2, 2009

(51) Int. Cl. B23P 15/14; F16H 55/17

(52) U.S. Cl. 74/459.5; 29/893.35

(57) ABSTRACT

Bevel and hypoid gears are used in power transmissions including automotive applications. Provided is a net shaped bevel or hypoid gear having a generally annular gear body including a plurality of radially outwardly extending gear teeth formed from a generally annular blank made of powdered metal. Also provided is a method for manufacturing a net shaped bevel or hypoid gear including the steps of providing and optionally heat treating a generally ring-shaped or annular blank made of metal powder, then incrementally deforming the blank by orbitally forming or roll forming to produce a net shaped gear member with a plurality of outwardly extending gear teeth, which may be of a bevel or hypoid type.

### TECHNICAL FIELD

The present invention relates to net shaped bevel and hypoid gears, more specifically to a bevel or hypoid gear formed from metal powder and a method for manufacturing same.

### BACKGROUND OF THE INVENTION

Bevel ring gears are well known and commonly used in power transmission applications. Among known bevel gears are helical bevel gears, spiral bevel gears, hypoid gears and the like. Spiral bevel ring gears typically have a generally annular gear body having a surface including a plurality of radially outwardly extending gear teeth. The form of the gear tooth may be, for example, one of a straight, spiral and hypoid type.

While hypoid gears are similar in their general form to spiral bevel gears, hypoid gears differ by having spiral teeth that are curved and oblique, where the pitch surface of the tooth is a hyperboloid of revolution, hence the name. Hypoid gears operate on non-intersecting axes, which may be at right angles or otherwise. Hypoid gears are stronger than spiral bevel gears, engaging with a sliding action or motion which imparts extreme pressure on the gear teeth, enabling hypoid gears to operate more quietly and to be used for higher reduction ratios than spiral bevel gears. To achieve uniform, sliding engagement, the gears in meshing pairs have teeth with conjugate tooth profiles, which provide conjugate, i.e., uniform, rotary motion. These conjugate profiles are such that the teeth of the first gear in a pair can be described to roll on the teeth of the second gear in the pair.

Gears are typically manufactured by generating the tooth profile, for example, by cutting or hobbing; or by forming, for example, by forging. Bevel and hypoid gear tooth profiles are most commonly generated by using CNC gear cutting machines, special cutters and complex programming strategies. The gear blank, or workpiece, provided to the cutting process is typically a metal blank cut from bar stock and normalized by heat treatment to be surface machined, or formed as a blank by forging, upsetting or rolling. The workpiece is rotated at the same time as the cutter is fed, and a complex tooth profile is produced. The Gleason, Oerlikon and Klingelnberg designs of hypoid gears are the most widely used, especially in the automotive industry. All three methods use an involute gear form, but produce teeth with differing curvatures.

Gleason hypoid gears are produced with multi-bladed face milling cutters, where the gear blank is turned relative to the rotating cutter to make one inter-tooth groove, then the cutter is withdrawn and the blank is indexed into position for cutting the next tooth. Teeth in the Gleason system are arc shaped and their depth tapers. The Oerlikon and Klingelnberg systems combine rolling with the sideways motion of the teeth in a cutting machine that rotates both the cutter and the gear blank at predetermined relative speeds and without indexing. The involute tooth profile of Klingelnberg gears has constant-pitch teeth typically cut by a single-start tapered hob in two passes. The epicycloidal teeth of Oerlikon gears are produced with a face-type rotating cutter, where the cutter head has separate groups of cutters for roughing, outside cutting and inside cutting, and the feed is divided into two stages.

Finish processing of a bevel or hypoid gear after cutting may include a combination of heat treatment, rolling, lapping and other surface finishing operations. Gear cutting processes are disadvantaged by high cost, lengthy processing time, poor yields, cutting allowance material waste and reduced tooth surface strength.

Bevel or hypoid gears may also be produced by forging a gear to near net shape from a metal blank, where the blank is typically cut from bar or tube stock. One method includes hot upset-forging a round bar blank to form a disk-shaped intermediate, die-forging the disk to form a bottom closed annular body, punching out the center to form a bottom-opened annular ring, shot-blasting and reheating, then ring-rolling to a fourth intermediate article, orbitally forging the ring-rolled blank to form bevel or hypoid teeth thereon, normalizing and shot-blasting, punching out the inner burr and cold-coining to form end product. Another forging method includes warm forging a toroidally shaped blank in one or more steps, then finishing the forged intermediate by heat treating and surface finishing the gear teeth, for example, by lapping.

Gear forging processes are disadvantaged by multiple forging and reheating steps during which scale formation and decarburization of the steel may occur, the use of high forming pressures resulting in low tool life and post-forging finishing operations including sizing, machining and heat treatment that can result in lengthy processing time and high cost.

### SUMMARY OF THE INVENTION

A net shaped bevel or hypoid gear member formed by a method of incremental deformation is provided, having a generally annular gear body made of powder metal. The gear member includes a base surface and a gear tooth surface having a plurality of radially outwardly extending gear teeth. The form of the gear tooth can be of a type included in a helical, spiral, bevel, hypoid or a similar type gear. The plurality of radially outwardly extending gear teeth may also be referred to as the gear tooth surface. The base surface of the gear may be the mounting surface of the gear, for example, the surface which mates or assembles with or is attached to an adjoining part. The gear tooth surface is generally opposite the base surface, for example, the base surface may be the bottom surface of the gear and the gear tooth surface may be the top surface of the gear. The plurality of radially outwardly extending gear teeth generally define a frustoconical profile with a base generally parallel to the base surface and a profile generally characteristic of a helical, spiral, bevel, hypoid or similar type gear.

The gear body is formed by repeatedly and incrementally deforming a generally ring shaped or annular metal blank or workpiece made of powder metal. After forming, the gear member is characterized as “net shaped,” that is, the gear, including the gear teeth, requires little or no additional processing to achieve the gear's final, e.g., net shape, size or profile. The gear blank is incrementally deformed using two or more tools, at least one of which substantially resembles the features of the net shaped gear member that are being formed by that tool.

A tool has features which “substantially resemble” the features of the net shaped gear member, for example, by having features configured as a mirror or counterpart image or a conjugate of the gear member feature to be formed by the tool. The mirror image configured in the tool may be modified by draft angles, radii, or similar features typically incorporated into tooling utilized in the particular incremental deformation process. Tooling with the mirror image slightly modified by these types of features, for example, a surface modified to perform other functions during incremental forming; for example, modifying the tooth profile by providing a gap or draft angle to assist removal of the workpiece from the die, would also qualify as substantially resembling the corresponding features of the net shaped gear member.

The process of incremental deformation provided herein may include one or more of orbitally forging, radially roll forging and axially-radially roll forging. The annular gear blank may be put into motion, for example, rotation, during the process of incremental deformation. The movement of the tool, for example, the rotation of the tool, during the process of incremental deformation may be synchronized with the movement or rotation of the annular gear blank, and with the rotation or movement of another tool. The synchronization method and synchronization sequence of the tools and gear blank is determined by the requirements of the gear tooth profile or other features produced on the net formed gear member.

The annular gear blank, or work piece, is made of powder metal. The annular gear blank is similar in configuration to the net shaped annular gear member. Some portions of the gear blank may be proportionally larger than the corresponding portion of the net shaped gear member depending on the method of incremental deformation. For example, the gear blank portion including a plurality of radially outwardly extending gear teeth, may be proportionally larger than the net shaped gear tooth profile of the net shaped gear member. These proportionally larger portions, during incremental deformation, are subject to preferential or selective compaction and densification to develop desirable mechanical properties, for example, improved surface finish, increased hardness, toughness or strength, reduced grain size, preferred grain orientation, higher load carrying capacity and higher wear resistance.

A method of forming a bevel or hypoid gear member is provided, where a annular gear blank or workpiece made of metal powder is repeatedly and incrementally deformed to provide a bevel or hypoid gear of net shape with minimal material waste. The annular gear blank and the bevel or hypoid gear member each generally consist of a generally annular gear body having a surface portion including a plurality of radially outwardly extending gear teeth where the form of the tooth profile is of the type included in a bevel or a hypoid type gear. A portion of the annular gear blank is compacted and densified through incremental deformation by applying pressure with or against one or more tools.

At least one of the tools has features which substantially resemble the corresponding features of the net shaped gear member being formed by the tool. For example, a tool feature which substantially resembles a feature of the net shaped gear member may be configured as a mirror image, counterpart or conjugate of the corresponding feature of the gear member to be formed by the tool.

The powder metal annular or ring shaped gear blank may be heat treated and/or sintered, for example, in one of a neutral atmosphere or partial vacuum, prior to incrementally deforming the gear blank to form a net shaped gear member. A portion of or the entire blank may be heated to a predetermined temperature prior to being incrementally deformed.

The method of incremental deformation may be one of orbitally forging, where a first tool is fixed axially and moves in at least one of an orbital, spiral, planetary or straight-line motion relative to the gear blank; and a second tool may move in at least one of an axial and rotational direction relative to the first tool to form the bevel or hypoid gear. One or more of the tools may substantially resemble a portion of the net shaped gear, by providing features which are configured as, for example, a mirror or counterpart image or as a conjugate of corresponding features of the net shaped gear formed by the tool. The method of incremental deformation may require synchronizing the movement of one or more of the tools during the gear forming sequence.

Alternatively, the method of incremental deformation may be one of roll forming, where at least two axially rotating tools deform generally opposite sides of an annular gear blank. During the forming process at least one of the tools moves radially and at least one of the tools may move axially. The movement of the tools may be synchronized during the forming sequence, especially as required to accurately produce the net shaped tooth profile with a tool that includes features which are a mirror or counterpart image or conjugate of features of the net shaped tooth profile and gear tooth spacing. After roll forming, the net shaped surfaces of the gear, including the gear tooth surface, may be finished by additional processing, such as lapping, coining, rolling, burnishing or heat treatment, or a combination thereof, for example, to further improve the surface properties of the net shaped gear.

Advantages of current invention include, for example, a reduction of forming process steps, higher process yields, lower forming pressures compared with other forming methods contributing energy savings, minimal material waste, extended equipment and tooling longevity, reduced tooling costs and reduced work in process inventory from raw material to finished product. Further advantages of the current invention may include optimization of gear teeth characteristics such as strength, density, toughness, hardness, grain size and orientation, wear resistance and noise and vibration reduction.

The present invention will be described primarily in relation to bevel or hypoid gears, it being understood that the present invention is equally well suited to bevel gears having other tooth forms such as straight or spiral teeth. The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1A is a cross sectional side view of a generally annular net shaped gear member with a base and a plurality of radially outwardly extending gear teeth;

FIG. 1B is a plan view of the generally annular net shaped gear member of FIG. 1A;

FIGS. 2A and 2B are cross sectional side views of annular gear blanks of such type and configuration as may be deformed incrementally to provide the gear member of FIGS. 1A and 1B, in accordance with the embodiments described below;

FIG. 2C is a cross sectional side view of a tooth profile of the annular gear blank of FIG. 2B;

FIG. 3A illustrates incremental deformation by orbital forming, also known as orbital forging. FIG. 3A is an exploded cross sectional illustration of an orbital forming press and tools configured to incrementally deform a gear blank into a net shaped gear member, in accordance with a first embodiment within the scope of the invention;

FIG. 3B illustrates another embodiment of incremental deformation by orbital forming. FIG. 3B is an exploded cross sectional illustration of an orbital forming press and tools, in accordance with a second embodiment within the scope of the invention;

FIG. 4A illustrates incremental deformation by axially roll forming, also known as axially roll forging. FIG. 4A is an exploded cross sectional illustration of axially roll forming tools configured to incrementally deform a net shaped gear member, in accordance with a third embodiment within the scope of the invention;

FIG. 4B illustrates another embodiment of incremental deformation by axially roll forming. FIG. 4B is an exploded cross sectional illustration of axially roll forming tools configured to incrementally deform the net shaped gear member, in accordance with a fourth embodiment within the scope of the invention;

FIG. 5A illustrates incremental deformation by axial-radially roll forming, also known as axially-radially roll forging. FIG. 5A is an exploded cross sectional illustration of axial-radially roll forming tools configured to incrementally deform the net shaped gear member, in accordance with a fifth embodiment within the scope of the invention;

FIG. 5B illustrates another embodiment of incremental deformation by axial-radially roll forming. FIG. 5B is an exploded cross sectional illustration of axial-radially roll forming tools configured to incrementally deform the net shaped gear member, in accordance with a sixth embodiment within the scope of the invention;

FIG. 6A illustrates another embodiment of incremental deformation by axial-radially roll forming, also known as axially-radially roll forging. FIG. 6A is an exploded cross sectional illustration of axial-radially roll forming tools configured to incrementally deform the net shaped gear member, in accordance with a seventh embodiment within the scope of the invention;

FIG. 6B illustrates another embodiment of incremental deformation by axial-radially roll forming. FIG. 6B is an exploded cross sectional illustration of axial-radially roll forming tools configured to incrementally deform the net shaped gear member, in accordance with a eighth embodiment within the scope of the invention.

### DESCRIPTION OF THE PREFERRED EMBODIMENTS

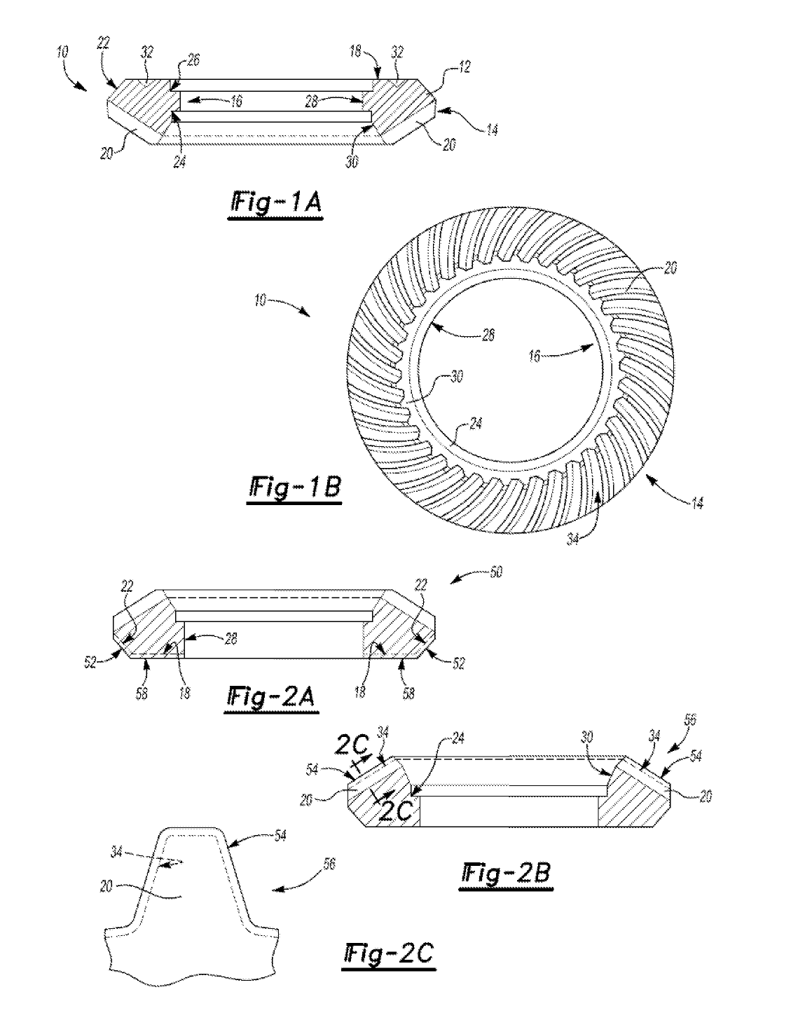

Referring to the drawings wherein like reference numbers correspond to like or similar components throughout the several figures, there is shown in FIGS. 1A and 1B a net shaped gear annular member generally indicated at 10, which may also be referred to throughout this description as net shaped gear member 10, annular gear member 10 and gear member 10. Net shaped gear member 10 includes a gear body 12 having an outer surface 14, a generally cylindrical stepped inner surface 16 and a base surface 18. In the preferred embodiment, gear member 10 is configured to be used in an automotive transmission application, such as in a rear axle differential. However, it should be appreciated that the present invention may be used within a variety of applications without changing the inventive concept.

A plurality of generally radially extending gear teeth 20 extend outwardly generally from inner surface 16 to outer surface 14 of gear member 10. Plurality of radially outwardly extending gear teeth 20 may also be referred to throughout this description as a plurality of gear teeth 20, and gear teeth 20, and is characterized by gear teeth profile 34. Plurality of gear teeth 20 generally define a frustoconical profile relative to base surface 18, characteristic of a gear of the hypoid or bevel type, for example. Plurality of gear teeth 20 is sufficiently configured to meshingly engage another gear member, such as a pinion gear member within a gearset, to transfer rotational torque thereto. Gear teeth 20 are preferably of the type included in gears of the bevel or hypoid type; however, those skilled in the art will recognize that other forms of gear teeth may be employed such those of the type included in spiral bevel gears or straight bevel gears, for example, while remaining within the scope of that which is claimed.

Gear teeth 20 of the present invention are characterized as being “net shaped,” that is, after gear member 10 is produced by incremental deformation, net shaped gear teeth 20 require little or no additional processing, such as hobbing, cutting, honing or machining, to shape or finish profile 34 of gear teeth 20. The method of forming gear teeth 20 will be described in greater detail herein below. An outer surface 14 of gear member 10 also includes a generally cylindrical outer transition surface 22 which transitions from gear teeth 20 to a base surface 18 and may be tapered, straight or stepped as required by the specific application, for example, to provide clearance or mesh with an adjacent part.

A generally stepped inner surface 16 may include one or more shoulders 24, 26, a generally cylindrical inner diameter 28 and generally cylindrical inner transition surface 30 which transitions from gear teeth 20 to a shoulder 24 or to inner diameter 28 in the absence of a shoulder 24. Inner diameter 28 and inner transition surface 30 may be tapered, straight, stepped or of another configuration as may be required by the specific application, for example, to provide clearance with a mating part or assembly surface.

Base surface 18 may typically be a mounting surface for gear member 10. Referring to FIG. 1A, base surface 18 is shown as a generally flat surface, however it may be, for example, generally flat, semi-spherical, stepped, tapered or otherwise configured as required to mesh with a mating surface. Base surface 18 may be mounted or attached to or assembled with a mating surface using means known to those of ordinary skill in the art.

Base surface 18 may include a shoulder 26 providing a transition to inner diameter 28. Shoulders 24, 26 may be stepped, tapered or of other configuration as may be required for processing, assembly or function. Shoulders 24, 26, inner diameter 28 and base surface 18 may also include surface features, such as raised dimples, knurls, grooves or indentations, for example, required for processing, assembly or function, or to facilitate the process of deforming annular gear blank 50, 56 to produce gear member 10.

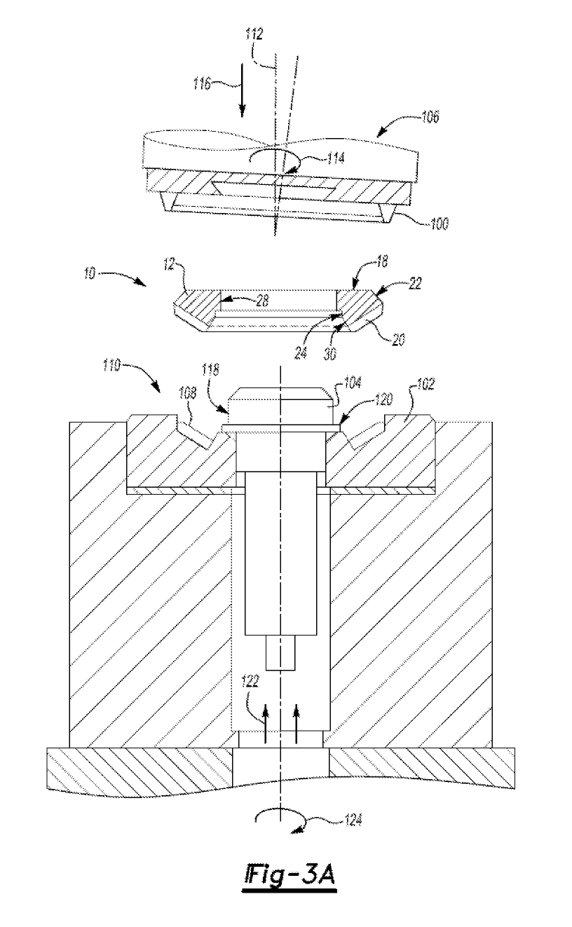

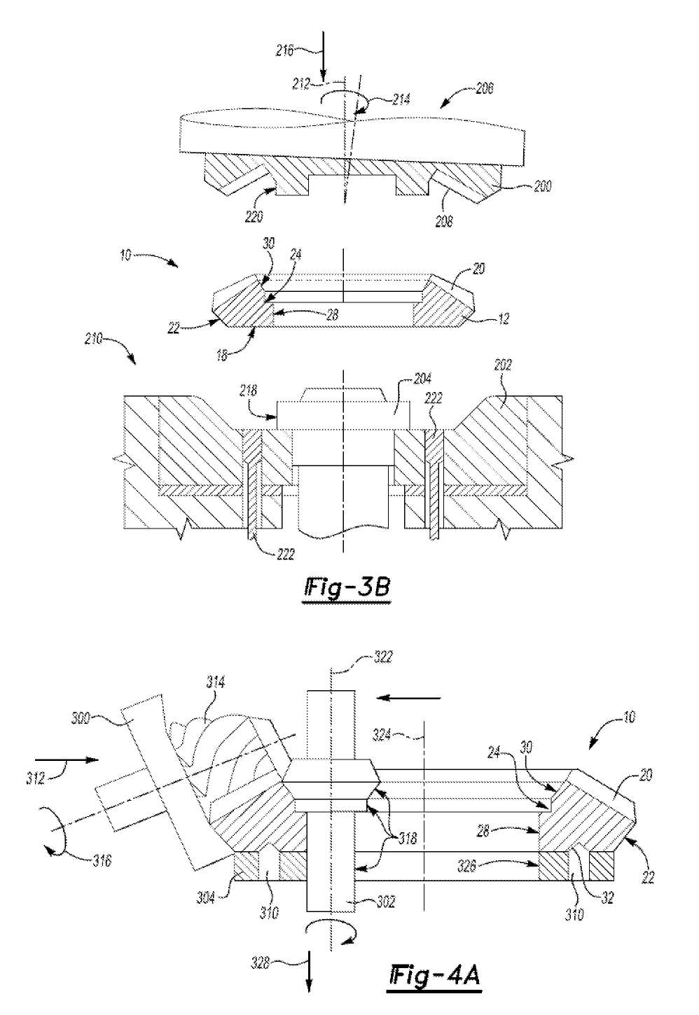

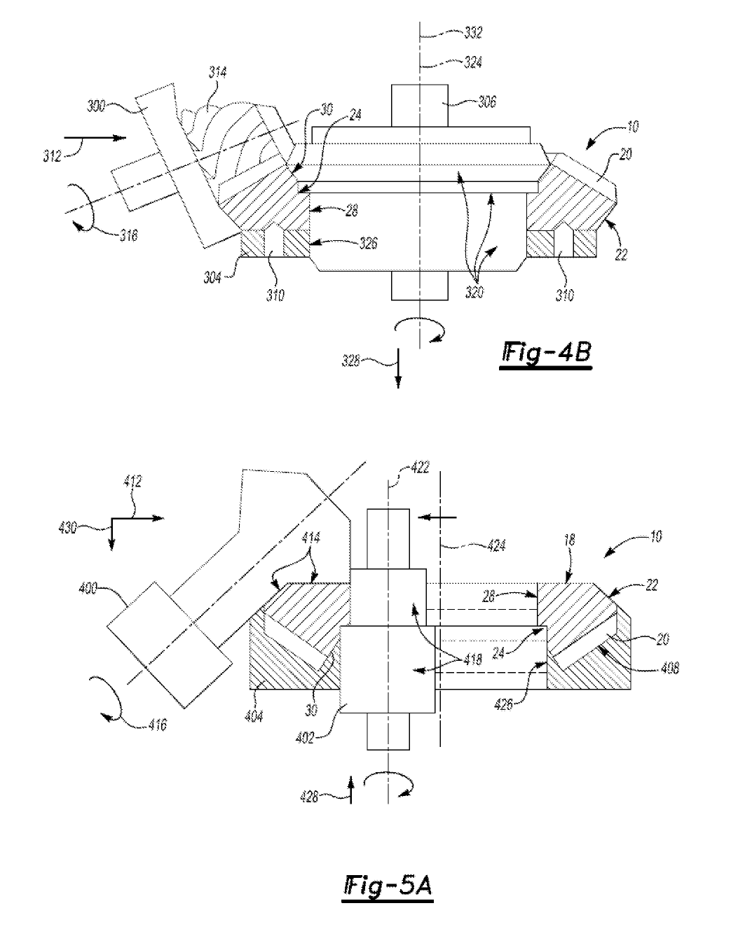

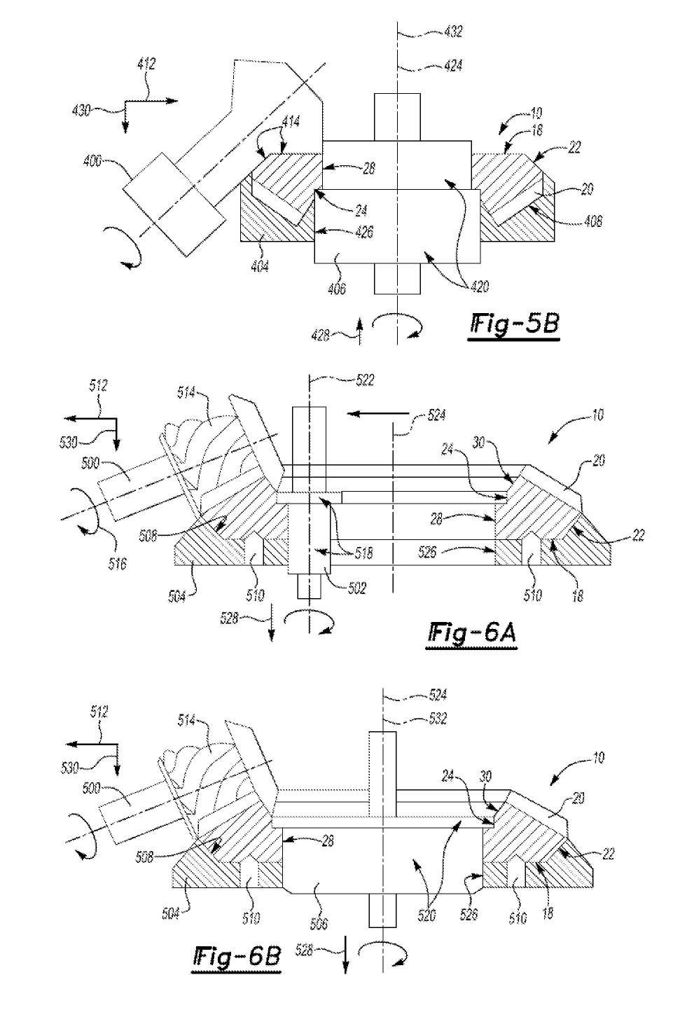

The present invention also provides a method of manufacturing gear member 10 described hereinabove. Eight embodiments of the invention are described for incrementally deforming gear blank 50, 56 into gear member 10. A first (see FIG. 3A) and second (see FIG. 3B) embodiment describe incrementally deforming gear blanks 50 and 56, respectively, into gear member 10 by orbital forming, also known as orbital forging. A third (see FIG. 4A) and fourth (see FIG. 4B) embodiment describe incrementally deforming gear blank 56 into gear member 10 by axially roll forming, also known as axially roll forging. A fifth (see FIG. 5A) and sixth (see FIG. 5B) embodiment describe incrementally deforming gear blank 50 into gear member 10 by axial-radially roll forming, also known as axial-radially roll forging. A seventh (see FIG. 6A) and eighth (see FIG. 6B) embodiment describe incrementally deforming gear blank 56 into gear member 10 by axial-radially roll forming, also known as axial-radially roll forging.

FIGS. 2A and 2B, where like reference numerals are used to describe like components in the different configurations, illustrate the general configurations of annular gear blanks 50 and 56, respectively, which may be incrementally deformed as described by the embodiments to provide a net shaped gear member 10. Throughout this description, annular gear blank 50, 56 may also be referred to as gear blank 50, 56 and blank 50, 56. Annular gear blank 50, 56 is similar in configuration to net shaped annular gear member 10. Gear blank 50, 56 is comprised of powder metal initially compacted into a green preform, then compressed to one of the configurations shown in FIG. 2A (50) and FIG. 2B (56) and sintered to achieve a density ratio of 92% to 97% of theoretical density.

Some portions of gear blank 50, 56 may be proportionally larger than the corresponding features of net shaped gear member 10. These proportionally larger portions, during incremental deformation, are subject to preferential or selective compaction and densification to achieve net shape, resulting in a localized density ratio of 99% to 100% of theoretical density. Further, densifying these portions results in localized improvement of mechanical properties, for example, improved surface finish, increased hardness, toughness and strength, reduced grain size and preferred grain orientation, higher load carrying capacity and higher wear resistance.

Referring to FIG. 2A, gear blank 50 is approximately 2% to 3% larger by volume than net shaped gear member 10. Gear blank 50 is further configured such that transition surface portion 52 and base surface portion 58 of gear blank 50 are proportionally larger to transition surface 22 and base surface 18, respectively, of net shaped gear 10. Net shaped surfaces 18 and 22 are indicated by dashed lines in FIG. 2A to illustrate the relative proportionality of blank surface portions 58 and 52 of gear blank 50 prior to being incrementally deformed to produce the net shape surfaces 18 and 22, respectively, of net shaped gear member 10. Accordingly, net shaped gear member 10, when formed from gear blank 50, is characterized by a 3% to 8% increase in localized density ratio to 99% to 100% at transition surface 22 and base surface 18, resulting in localized improvement of the mechanical properties of surfaces 18 and 22. Localized improvement of the surface hardness, strength, wear resistance or surface finish of surfaces 18 and 22 may be advantageous, for example, yielding improved strength, durability, noise management and vibration reduction benefits when surfaces 18 and 22 are used as mounting surfaces or mesh with mating components in application. Localized reduction of grain size at the surface may be advantageous, for example, yielding improved toughness. Incremental deformation of the surface may yield a preferred grain orientation, where a “preferred” grain orientation is one which yields improved load bearing capacity, resistance to wear or surface cracking or improved surface finish.

Referring to FIG. 2A, base surface 58 is shown as a generally flat surface, corresponding to the generally flat configuration of base surface 18 as shown in FIG. 1A. It is understood that base portion 58 of gear blank 50 may be configured, for example, as generally flat, semi-spherical, stepped, tapered or otherwise configured to be proportionally larger than the corresponding configuration of base surface 18 of net shaped gear member 10.

The remaining portions of gear blank 50, for example, the gear tooth surface and inner diameter surface of gear blank 50, are provided in near net shape and size prior to being incrementally deformed. A “near net” portion, as used herein, is meant generally to indicate a portion of the gear blank which is provided with a size, profile or shape nearly at the net shape of gear member 10, such that as a result of incremental deformation of the near net portion of the gear blank, surface compaction results in 0% to 2% increase in localized density ratio and a nominal change in volume.

Similarly, referring now to FIGS. 2B and 2C, gear blank 56 is approximately 2% to 3% larger by volume than net shaped gear member 10. Gear blank 56 is further configured such that gear tooth profile portion 54 of gear blank 56 is proportionally larger than gear tooth profile 34 of net shaped gear member 10. Net shaped gear tooth profile 34 is indicated by dashed lines in FIGS. 2B and 2C to illustrate the relative proportionality of gear tooth profile portion 54 of gear blank 56 prior to being incrementally deformed to produce net shaped gear tooth profile 34 of net shaped gear member 10. Accordingly, net shaped gear member 10, when formed from gear blank 56, is characterized by a 3% to 8% increase in localized density ratio to 99% to 100% in gear tooth profile 34, resulting in localized improvement of the mechanical properties of gear tooth profile 34. Localized improvement of the surface hardness, wear resistance or surface finish of gear tooth profile 34 may be advantageous, for example, yielding improved dimensional accuracy and stability of the gear tooth form, improved tooth to tooth mesh, strength, durability, noise management and vibration reduction benefits in application. Localized reduction of grain size at the surface may be advantageous, for example, yielding improved toughness. Incremental deformation of the surface may yield a preferred grain orientation, where a “preferred” grain orientation is one which yields improved load bearing capacity, resistance to wear or surface cracking or improved surface finish, especially in areas such as the flank of the tooth profile 34 which are subject to loading when gear member 10 is meshed with another gear member.

The remaining portions of gear blank 56, for example, the base surface and inner diameter surface of gear blank 56, are provided in near net shape and size prior to being incrementally deformed. A “near net” portion, as used herein, is meant generally to indicate a portion of the gear blank which is provided at or nearly at the net shape of gear member 10, such that following incremental deformation of the near net portion of the gear blank, surface compaction results in 0% to 2% increase in localized density ratio and a nominal change in volume.

Gear blank 50, 56 may be preheated or heat treated prior to being incrementally deformed, as described by any of the embodiments, into gear member 10. The preheating or heat treatment may occur in a carburizing, carbonitriding, nitriding and neutral atmosphere, where all or a portion of gear blank 50, 56 may be subjected to preheating or heat treatment to produce properties in gear blank 50, 56 which may be advantageous to the effectiveness of the deformation process or to the resultant physical characteristics of gear member 10 or gear teeth 20. Such advantages may include, for example, preheating the gear blank 50, 56 to decrease the tool pressure required to incrementally deform portions of gear blank 50, 56; carburizing, carbonitriding or nitriding certain surface areas to offset decarburization during the forming process or prepare a portion of gear member 10 for subsequent heat treat operations, such as induction hardening of, for example, gear teeth 20 or base surface 18.

FIG. 3A through 6B, where like reference numerals are used to describe like components in the different embodiments, illustrate eight embodiments for incrementally deforming gear blank 50, 56 (see FIG. 2A, 2B) into gear member 10 (see FIGS. 1A and 1B). In FIG. 3A through 6B, net shaped annular gear member 10 is shown after the forming method is completed, e.g., in its net shape or finished state.

In each embodiment, the method of incremental deformation uses at least two tools, where at least one of the tools moves relative to the other tool to form a net shaped gear member 10. Further, in each embodiment, at least one of the two or more tools substantially resembles the corresponding features of the net shaped gear member 10 that are being form by that tool. A tool “substantially resembles” the corresponding features of net shaped gear member 10, for example, by including in the tool features configured as a mirror image, counterpart or conjugate of the corresponding features of the gear member to be formed by that tool.

A tool substantially resembles features of net shaped gear member 10, for example, by including features which are configured as a mirror image of features of gear member 10 to be formed by the tool, that is, by providing a profile or surface substantially conforming in profile and shape to corresponding features in the net shaped gear member 10. The mirror image features of the tool may be reversely arranged or configured in comparison with the corresponding features of the net shaped gear member 10, with reference to an intervening axis or plane. For example, a tool is a mirror image of the part by providing a protrusion in the tool that corresponds in mirror symmetry to an indentation in the part, whereby as a result of the forming process, the protrusion of the tool forms or produces the corresponding indentation in the part. A mirror image could also be described as a counterpart or counterpart image, that is, the features of the tool which substantially resemble features of net shaped gear member 10 provide a surface that is counterpart to the corresponding features in the net shaped gear member 10 because the tool surface and corresponding feature of gear member 10 have a spatial arrangement that fit, complete or complement one another.

The mirror or counterpart image of the tool may be modified by draft angles, radii, or similar features typically incorporated into tooling utilized in the specific incremental deformation process. Tooling with the mirror or counterpart image slightly modified by these types of features, for example, a mirror or counterpart image surface minimally modified by adding a draft angle to assist removal of the workpiece from the die, would also be defined as substantially resembling the features of the net shaped gear member.

A tool may also substantially resemble corresponding features of net shaped gear member 10 by including features which are configured as conjugate of corresponding features of gear member 10 to be formed by the tool. For example, a tool may provide a tool tooth form or profile that is conjugate to net shaped gear tooth profile 34, where the conjugate portion of net shaped gear tooth profile 34 is produced by mutual or rolling motion of the tool and the gear blank. The conjugate portion of the tool tooth form will generate the conjugate portion of the gear tooth profile as the tool rolls uniformly against or together with the conjugate portion of the gear tooth blank. Tooling that is conjugate to the feature of the net shaped gear member being formed and slightly modified by gap allowances or other features to assist the forming process would also be defined as substantially resembling the features of the net shaped gear.

Additionally, a tool may substantially resemble corresponding features of net shaped gear member 10 by being configured to include certain tool features with are mirror or counterpart images of certain corresponding features and to include other tool features which are conjugate to other corresponding features of net shaped gear member 10. Referring now to FIGS. 2B and 2C, a tool that incrementally deforms the gear tooth profile portion 54 to produce net shaped gear tooth profile 34 may be, for example, configured in some areas of the tool to be a mirror or counterpart image of some features of net shaped tooth profile 34, and configured in other areas of the tool as a conjugate of other features of tooth profile 34. For example, the area of a tool that incrementally deforms the tip or crest of tooth blank profile 54 may substantially resemble the tip or crest of tooth profile 34 by providing a mirror image or counterpart of the tip or crest of tooth profile 34. The same tooth forming tool may be configured in another area as a conjugate to the tooth flank area, such that the flank area of the tooth forming tool rolls uniformly over the flank of the tooth blank profile 54, when the normal line of contact between the tooth tool flank and flank of the gear tooth profile 34 formed as a result of incremental deformation corresponds to the pitch point of the conjugate form or profile. The same tooth forming tool may be configured in yet another area as a mirror or counterpart image of the root of tooth profile 34 by providing a counterpart image that is slightly larger than the root profile of net shaped tooth profile 34, where the slightly larger profile assists the process of incrementally deforming the root of tooth blank profile 54 into the net shaped root of gear tooth profile 34. A tool providing a counterpart image of the root area that is slightly larger than the net formed root profile is within the definition of “substantially resembling” the feature of the net shaped gear being formed or produced.

The tooth tip, also known as the tooth crest, tooth flank, tooth root and pitch point of the tooth profile are not illustrated in the figures, however these terms as used herein are commonly understood by those of ordinary skill in the art of gear tooth forming.

### First and Second Embodiments

### Orbital Forming

In a first embodiment of incremental deformation, and referring now to FIG. 3A, there is shown gear member 10 formed by orbital forging, also known as orbital forming. Gear member 10 is formed by incrementally deforming a gear blank 50 (not shown, see FIG. 2A) by repeatedly orbitally applying sufficient pressure locally to base portion 58 and transition portion 52 (shown in FIG. 2A) of blank 50. The pressure to deform gear blank 50 is applied by a first tool 100 or tool assembly 106 (where hereinafter “tool 100” refers to either a tool 100 or tool assembly 106) progressing axially 116 toward a second tool 102 or tool assembly 110 (where hereinafter “tool 102” refers to either a tool 102 or tool assembly 110). A first tool 100 is fixed axially 112 and moves in at least one of an orbital, spiral, planetary or straight-line motion 114 to repeatedly exert pressure on gear blank 50, causing blank 50 to deform against the profile of first tool 100 and into the cavity and profile of second tool 102. As first tool 100 progresses axially 116 toward second tool 102, the incrementally increasing pressure causes gear blank 50 to further deform to produce net shaped gear member 10.

Tool 100 is configured to substantially resemble a counterpart or mirror image of base surface 18 and transition surface 22 of net shaped gear 10. The movement of first tool 100 may be synchronized with the axial progression toward second tool 102 and gear blank 50 to optimize deformation of gear blank 50 as blank 50 is pressed into the cavity and profile of second tool 102 and against the profile of first tool 100, and to optimize metal compaction at surfaces 52 and 58 of blank 50 (see FIG. 2A) by tool 100.

As shown in FIG. 3A, first tool 100 compacts surfaces 52 and 58 of blank 50 to produce net shaped base surface 18 and outer transition surface 22 of gear member 10. Surfaces 18 and 22 are characterized, after compaction and forming, by an increased density ratio and improved mechanical properties, as previously discussed.

Tool 100 may also form a shoulder 26 (shown in FIG. 1A). Tool 100 incrementally applies pressure locally to gear blank 50, causing blank 50 to deform against tool 102 and tool 104. Tool 102 is configured to substantially resemble, by including a combination of mirror and conjugate features, plurality of radially outwardly extending gear teeth 20 and inner transition surface 30, as generally indicated at 108 in FIG. 3A.

Core tool 104, which may be referred to as a core rod or core rod assembly, or punch or punch assembly, is configured to include a mirror image of inner diameter 28 and may be configured to include a mirror image of shoulder 24 and all or part of inner transition surface 30. Alternatively, tool 102 may be configured to include a mirror image of shoulder 24 and inner transition surface.

Shoulder 24 and/or inner diameter 28 may be formed to include surface features, such as dimples, knurls, grooves or indentations. The dimples, knurls, grooves, indentations, or similar surface features may, for example, be required for function or assembly of finished gear member 10, affect the kinematics of the deformation process, or facilitate the ejection process of gear member 10 from tool 102. These surface features may be produced by deforming shoulder 24 and/or inner diameter 28 against tool 104, where a portion of tool 104 is configured to substantially resemble net shaped surface features of gear member 10. For example, surface 118, 120 of tool 104 may provide a counterpart or mirror image of corresponding surface features being formed in net shaped gear 10.

Additionally, gear blank 50 may be provided with a proportionally larger portion corresponding to shoulder 24 and/or inner diameter 28, such that localized densification results from compaction of this portion during formation of surface features. For purposes of illustration, if the surface feature is, for example, a knurl, localized increases in surface hardness and density may be beneficial to improve the strength and load carrying characteristics of the knurl surface, when, for example, the knurl surface is provided for assembly by press fitting to a mating component.

Referring again to FIG. 3A, ejection of gear member 10 from tool 102 after forming may occur by axially raising core 118 in the direction of arrow 122 and rotating core 118 in the direction of arrow 124 to eject gear member 10 from tool 102 with a twisting motion that may complement profile 34 of gear teeth 20. This method of ejection may be further facilitated by meshing of surfaces 118, 120 of tool 104 with surface features, for example, dimples or knurls, which may be formed on inner diameter 28 or shoulder 24 of net shaped gear member 10.

In a second embodiment of incremental deformation, and referring now to FIG. 3B, there is shown gear member 10 formed by orbital forging, also known as orbital forming. Gear member 10 is produced by incrementally deforming gear blank 56 (see FIGS. 2B and 2C) by repeatedly orbitally applying sufficient pressure locally to gear tooth profile portion 54 (shown in FIGS. 2B and 2C) of blank 56. The pressure to deform gear blank 56 is applied by a first tool 200 or tool assembly 206 (where hereinafter “tool 200” refers to either a tool 200 or tool assembly 206) progressing axially 216 toward a second tool 202 or tool assembly 210 (where hereinafter “tool 202” refers to either a tool 202 or tool assembly 210). A first tool 200 is fixed axially and the axis 212 of tool 200 moves in at least one of an orbital, spiral, planetary or straight-line motion 214; to repeatedly exert pressure on gear blank 56, causing blank 56 to deform against the profile of first tool 200 and into the cavity and profile of second tool 202. As first tool 200 progresses axially 216 toward second tool 202, the incrementally increasing pressure causes blank 56 to deform gear blank tooth profile portion 54 to be compacted to produce net shaped gear tooth profile 34 and net shaped gear member 10.

The movement of first tool 200 may be synchronized with the axial progression toward second tool 202 and gear blank 56 to optimize the deformation of gear blank 56 as blank 56 is pressed against the configuration of second tool 202 and into the configuration of first tool 200, and to optimize flow and compaction of gear tooth profile portion 54 against the profile of tool 200, where tool 200 is configured to substantially resemble a net shaped plurality of radially outwardly extending gear teeth 20 by providing certain features which are configured to be conjugate of certain features of net shaped gear tooth profile 34, for example, the flank defining the tooth pitch point, and by providing other features which are configured to be counterpart or mirror image of other features of gear tooth profile 34, for example, the features defining the net shaped gear tooth tip and root.

As shown in FIG. 3B, tool 200 incrementally applies pressure locally to gear blank 56, causing blank 56 including gear tooth profile portion 54 to be deformed against cavity 208 to compact gear tooth profile portion 54 into net shaped gear tooth profile 34, and further causing blank 56 to be deformed against tool feature 220 to compact inner transition surface 30 and shoulder 24 of gear member 10. Tool 202 is configured to include a mirror image of base surface 18 and outer transition surface 22. Core tool 204, which may be referred to as a core rod or core rod assembly, or punch or punch assembly, is configured to include a mirror image of net shaped inner diameter 28, and may also form a shoulder 26 (shown in FIG. 1A) at the transition between inner diameter 28 and base surface 18. Shoulder 26 and/or inner diameter 28 may also be formed to include surface features, such as dimples, knurls, grooves or indentations. These surface features may be formed by deforming the surface of shoulder 26 and/or inner diameter 28 of gear blank 56 against a tool surface 218, where a portion of tool 204 is configured to substantially resemble the surface features. For example, surface 218 of tool 204 may provide a mirror image of the surface features being formed in net shaped gear 10. Additionally, gear blank 56 may be provided with a proportionally larger portion corresponding to the shoulder 26 and/or inner diameter 28, such that localized densification results from compaction of this portion during formation of surface features, as previously discussed for the first embodiment.

Referring again to FIG. 3B, ejection of gear member 10 from second tool 202 after forming may occur as described by the first embodiment (see FIG. 3A), by axially raising and rotating tool 204 so as to eject gear member 10 from tool 202. This method of ejection may be facilitated by a shoulder 26 (shown in FIG. 1A) or surface features (as previously described) formed on a surface of inner diameter 28 or on a shoulder 26. Alternatively, a configuration of ejection pins 222, which may also be known as knock-out pins, may be used to assist removal of gear member 10 from tool 202, using ejection methods and configurations familiar to those skilled in the art.

### Third and Fourth Embodiments

### Radially Roll Forming

In a third embodiment of incremental deformation, and referring now to FIG. 4A, there is shown gear member 10 formed by radially roll forming, also known as radially roll forging. The gear blank 56 (not shown, see FIGS. 2B and 2C) is positioned on platen tool 304 prior to forming and may be fixed to or positioned on platen tool 304 by a method or mechanism familiar to those skilled in the art. Such a method may include fabricating surface features 32, shown in FIG. 1A, which may be configured, for example, as dimples, grooves, slots, or holes on gear blank 56 during the fabrication of gear blank 56, with surface features 32 placed at increments on base surface 18 surface of blank 56 to coincide in position with holes or slots 310 in platen tool 304. Holes or slots 310 may contain pins, dowels, bolts or other similar tool details (not shown) which, when such details are inserted or fastened into surface features 32 of gear blank 56, function to retain gear blank 56 to platen tool 304 while gear blank 56 is incrementally deformed into gear member 10. Alternatively, platen tool 304 may contain pins, dowels, bolts or other similar tool details which, as blank 56 is deformed against platen tool 304, create desired surface features 32 in gear blank 56 as it is deformed into gear member 10. The surface features 32, as formed, function to retain gear blank 56 to platen tool 304 while gear blank 56 is subsequently incrementally deformed into gear member 10.

As shown in FIG. 4A, gear member 10 is incrementally deformed by an outer roll tool 300. Outer roll tool 300 includes a profiled section 314, and applies sufficient pressure locally on transition surface 22 and gear tooth profile portion 54 of gear blank 56 (not shown, see FIGS. 2B and 2C) while moving radially in the direction of arrow 312 relative to an inner roll tool 302, to form a gear member 10. Gear blank 56 may be provided with a proportionally larger portion corresponding to transition surface 22, similar to surface portion 52 shown in FIG. 2A, to facilitate compaction and localized densification of gear blank 56 by outer roll tool 300.

Outer roll tool 300, which may also be known by those skilled in the art as an OD roll, main roll or king roll, is configured to substantially resemble a plurality of radially outwardly extending gear teeth 20 and transition surface 22, by providing a profile which has features which are counterpart or conjugate to corresponding features of net shaped gear teeth 20 and transition surface 22. Outer roll tool 300 rotates axially 316 as it progresses radially in the direction of arrow 312, applying pressure locally with profile section 314 to incrementally deform gear blank 56, including compacting gear tooth profile portion 54 to produce net shaped gear tooth profile 34, which is characterized by an increased density ratio and localized improvement in mechanical properties after forming.

In FIG. 4A, inner roll tool 302 rotates axially on an axis 322 which may be fixed radially or be configured to progress radially outward, In either circumstance, inner roll tool 302 maintains a position where outer surface 318 of inner roll tool 302 remains in proximate contact with inner diameter 326 of platen tool 304. Outer surface 318 is configured to substantially resemble corresponding features of net shaped inner diameter 28, shoulder 24 and inner transition surface 30. As outer roll tool 300 progresses radially in the direction of arrow 312 toward inner roll tool 302, gear blank 56 is deformed against outer surface 318 of inner roll tool 302 to produce net shaped inner diameter 28, shoulder 24 and inner transition surface 30 of gear member 10. Inner roll tool 302 may also be known by those skilled in the art as an ID roll or idler roll.

In FIG. 4A, gear blank 56 and platen tool 304 rotate relative to the rotation of inner roll tool 302 and outer roll tool 300 such that gear blank 56 is incrementally deformed circumferentially into a gear member 10. The rotational and radial movements of each or both of inner roll tool 302 and outer roll tool 300, including profile section 314, and the rotational movement of platen tool 304 and gear blank 56 may be synchronized as required to form a plurality of radially outwardly extending gear teeth 20 and net shaped gear tooth profile 34.

Shoulder 24 and inner diameter 28 may also be formed to include surface features, such as dimples, knurls, grooves or indentations, by deforming the surface of the shoulder 24 and inner diameter 28 of gear blank 56 against a surface 318 of inner roll tool 302, where a portion of tool 302 is configured to substantially resemble the surface features of net shaped gear member 10. For example, surface 318 of tool 302 may provide a counterpart or mirror image of corresponding surface features formed in net shaped gear 10. Additionally, gear blank 56 may be provided with a proportionally larger portion corresponding to the shoulder 24 and inner diameter 28, such that localized densification results from compaction of this portion during formation of surface features, as previously discussed.

As understood by those skilled in the art, inner roll tool 302, outer roll tool 300 and/or platen tool 304 in FIG. 4A may include additional or alternative configurations substantially resembling additional or alternative features corresponding to features of net shaped gear member 10. As an example, shoulder 26 (shown in FIG. 1A) may be formed by configuring inner roll tool 302 or platen tool 304 to substantially resemble shoulder 26, such that as gear blank 56 is incrementally deformed, shoulder 26 would be formed in gear member 10. It is also understood by those skilled in the art that the surface of platen 304 which meshes with gear blank 56 is configured to substantially resemble base surface 18. As illustrated in FIG. 4A, platen 304 is shown to have a generally flat surface meshing with and in counterpart to the configuration of base surface 18, which is also shown in FIG. 4A as generally flat. Therefore, it is understood that when base surface 18 is otherwise configured, for example, with a tapered profile, the corresponding surface of platen 304 would be configured in counterpart, for example, with a tapered profile mirroring that of base surface 18.

In a fourth embodiment of incremental deformation, and referring now to FIG. 4B, there is shown gear member 10 formed by radially roll forming, also known as radially roll forging. The gear blank 56 (see FIGS. 2B and 2C) is positioned on platen tool 304 prior to forming and may be fixed to or positioned on platen tool 304 in the same manner as described for the third embodiment and shown in FIG. 4A. As shown in FIG. 4B, gear blank 56 is incrementally deformed by an outer roll tool 300, in the same manner as described for the third embodiment and shown in FIG. 4A, to produce gear member 10.

Referring to FIG. 4B, an inner roll tool 306 provides an outer surface 320 configured to substantially resemble the corresponding inner surface 16 features, by providing a mirror image of, for example, net shaped inner diameter 28, shoulder 24, and transition surface 30 of net shaped gear member 10. Outer surface 320 is also configured to be coaxial with inner diameter 326 of platen tool 304, and inner roll tool 306 rotates axially on an axis 332 which is coincident with axis 324 of platen tool 304. Accordingly, inner roll tool 306 maintains a position where an outer surface 320 of inner roll tool 306 remains in proximate contact with inner diameter 326 of platen tool 304, so as outer roll tool 300 progresses radially in the direction of arrow 312 toward inner roll tool 306, gear blank 56 is deformed against outer surface 320 of inner roll tool 306 to produce net shaped inner diameter 28, shoulder 24 and inner transition surface 30 of net shaped gear member 10. The inner roll tool 306 may also be configured to progress in an axial direction of arrow 328 so as to apply sufficient pressure to incrementally deform gear blank 56 against platen tool 304 and outer surface 320 of inner roll tool 306. Inner roll tool 306 may also be known by those skilled in the art as an ID roll, idler roll or mandrel.

In FIG. 4B, gear blank 56 and platen tool 304 rotate relative to the rotation of inner roll tool 306 and outer roll tool 300 such that gear blank 56 is incrementally deformed circumferentially to produce net shaped gear member 10. The rotational and radial movements of each or both of inner roll tool 306 and outer roll tool 300 and the rotational movement of platen tool 304 and gear blank 56 may be synchronized as required to generate gear tooth profile 34 and produce net shaped plurality of radially outwardly extending gear teeth 20.

Shoulder 24 and/or the inner diameter 28 may also be formed to include surface features as previously described in the first embodiment, for example, dimples, knurls, grooves or indentations, by deforming the surface of the shoulder 24 and/or inner diameter 28 of gear blank 56 against a surface 320 of inner roll tool 306 substantially resembling the surface features. The dimples, knurls, grooves, indentations, or similar surface features may, for example, be required for function or assembly of finished gear member 10, affect the kinematics of the deformation process, or facilitate the rotation of gear blank 56 and platen tool 304 during the deformation process.

As understood by those skilled in the art, inner roll tool 306, outer roll tool 300 and/or platen tool 304 in FIGS. 4A and 4B may include additional or alternative configurations substantially resembling additional or alternative features desirable in net shaped gear member 10. As an example, shoulder 26 (shown in FIG. 1A) may be formed by configuring inner roll tool 306 or platen tool 304 to substantially resemble shoulder 26, such that as gear blank 56 is incrementally deformed, net shaped shoulder 26 would be formed in gear member 10. As described for the third embodiment, platen 304 may be configured as a counterpart of the corresponding features of base surface 18.

### Fifth, Sixth, Seventh and Eighth Embodiments

### Radially-Axially Roll Forming

In a fifth embodiment of incremental deformation, and referring now to FIGS. 5A and 5B, gear member 10 is incrementally deformed by axially-radially roll forming, also known as axially-radially roll forging. A gear blank 50 (see FIG. 2A) is positioned on platen tool 404 prior to forming. Platen tool 404 includes a cavity 408 which is configured to substantially resemble corresponding features of net shaped gear member 10, including net shaped plurality of radially outwardly extending gear teeth 20 and inner transition surface 30, such that as localized pressure is applied axially and radially on gear blank 50, blank 50 is compacted into cavity 408 to produce net shaped plurality of radially outwardly extending gear teeth 20 having gear tooth profile 34 and inner transition surface 30 of gear member 10.

As shown in FIG. 5A, gear member 10 is incrementally deformed by an outer roll tool 400 applying sufficient pressure locally on transition surface portion 52 and base surface portion 58 of gear blank 50 (see FIG. 2A), by moving radially in the direction of arrow 412 relative to an inner roll tool 402, and moving axially in the direction of arrow 430 relative to platen tool 404, while rotating axially 416 to produce net shaped gear member 10. Outer roll tool 400, which may also be known by those skilled in the art as an OD roll, main roll or king roll, has a profile 414 configured to substantially resemble corresponding features of net shaped gear member 10, by providing a mirror image of net shaped base surface 18 and outer transition surface 22 of gear member 10. As outer roll 400 incrementally deforms blank surface portions 52 and 58, these surface portions are compacted to provide increased density ratios localized in net shaped surfaces 18 and 22 and to produce improved localized mechanical properties, as previously discussed.

In FIG. 5A, the inner roll tool 402 rotates axially on an axis 422 which may be fixed radially or be configured to progress radially outward, in either circumstance such that inner roll tool 402 maintains a position where outer surface 418 of inner roll tool 402 remains in proximate contact with inner diameter 426 of platen tool 404, so as outer roll tool 400 progresses radially in the direction of arrow 412 toward inner roll tool 402, gear blank 50 is deformed against outer surface 418 of inner roll tool 402 to produce net shaped inner diameter 28 and shoulder 24. Inner roll tool 402 may also be known by those skilled in the art as an ID roll or idler roll.

Referring again to FIG. 5A, the gear blank 50 and platen tool 404 rotate relative to the rotation of inner roll tool 402 and outer roll tool 400 such that gear blank 50 is incrementally deformed circumferentially into cavity 408 of platen tool 404 to produce net shaped gear teeth 20 and gear member 10. The rotational, axial and radial movements of each or both of inner roll tool 402 and outer roll tool 400 and the rotational movement of platen tool 404 and gear blank 50 may be synchronized as required to produce a net shaped plurality of radially outwardly extending gear teeth 20 in cavity 408 of platen tool 404. Shoulder 24 and/or inner diameter 28 may also be formed to include surface features, such as dimples, knurls, grooves or indentations, by deforming the surface of shoulder 24 and/or inner diameter 28 against a surface 418, 420 of inner roll tool 402, 406 where surface 418, 420 substantially resembles the desired surface features. The dimples, knurls, grooves, indentations, or similar surface features may, for example, be required for function or assembly of finished gear member 10, affect the kinematics of the deformation process, or facilitate the rotation of the gear blank 50 and platen tool 404 during the deformation process.

Not illustrated but understood by those skilled in the art, inner roll tool 402, outer roll tool 400 and/or platen tool 404 in FIG. 5A may include additional or alternative configurations substantially resembling additional or alternative features desirable in gear member 10. As an example, shoulder 26 (shown in FIG. 1A) may be formed by configuring inner roll tool 402 or outer roll tool 400 to substantially resemble shoulder 26, such that as gear blank 50 is incrementally deformed, shoulder 26 would be formed into gear member 10.

Referring again to FIG. 5A, ejection of gear member 10 from cavity 408 of platen tool 404 after forming may occur by axially raising inner roll tool 402 in the direction of arrow 428 and rotating inner roll tool 402 so as to eject gear member 10 from cavity 408 of platen tool 404 with a twisting motion complementing surface profile 34 of gear teeth 20, minimizing distortion of gear teeth 20. This method of ejection by twisting gear member 10 as it is raised out of cavity 408 of platen tool 404 may be further facilitated by meshing of surface 418 of tool 402 with the surface features, for example, dimples or knurls, which may be formed on inner diameter 28 or shoulder 24 of the gear member 10.

In a sixth embodiment of incremental deformation, referring now to FIG. 5B, gear member 10 is incrementally deformed by axially-radially roll forming. A gear blank 50 (see FIG. 2A) is positioned on platen tool 404 prior to forming, in the same manner as described for the fifth embodiment. As shown in FIG. 5B, gear blank 50 is incrementally deformed by an outer roll tool 400, in the same manner as described for the fifth embodiment, to produce a gear member 10 where net shaped transition surface 22 and base surface 18 are characterized by an increased density ratio and localized improved mechanical properties.

Referring to FIG. 5B, an inner roll tool 406 provides an outer surface 420 with features substantially resembling corresponding features of gear member 10, by providing a mirror image of net shaped inner diameter 28 and shoulder 24 of gear member 10. As shown in FIG. 5B, inner roll tool 406 rotates axially on an axis 432 which is coincident with axis 424 of platen tool 404 such that inner roll tool 406 maintains a position where the outer surface 420 of inner roll tool 406 remains in proximate contact with inner diameter 426 of platen tool 404. As outer roll tool 400 progresses radially in the direction of arrow 412 and axially in the direction of arrow 430 toward inner roll tool 406, gear blank 50 is deformed against outer surface 420 of inner roll tool 406 to produce inner diameter 28 and shoulder 24 of gear member 10. Inner roll tool 406 may also be known by those skilled in the art as an ID roll, idler roll or mandrel.

In FIG. 5B, the gear blank 50 and platen tool 404 rotate relative to the rotation of inner roll tool 406 and outer roll tool 400 such that gear blank 50 including surface area 54 is incrementally deformed circumferentially into cavity 408 of platen tool 404 to form net shaped gear teeth 20 and gear member 10. The rotational, axial and radial movements of each or both of inner roll tool 406 and outer roll tool 400 and the rotational movement of platen tool 404 and gear blank 50 may be synchronized as required to produce a net shaped plurality of radially outwardly extending gear teeth 20 in cavity 408 of platen tool 404. Shoulder 24 and/or inner diameter 28 may also be formed to include surface features, such as dimples, knurls, grooves or indentations, by deforming the surface of shoulder 24 and/or inner diameter 28 against a surface 420 of inner roll tool 406 substantially resembling the desired surface features. The dimples, knurls, grooves, indentations, or similar surface features may, for example, be required for function or assembly of finished gear member 10, affect the kinematics of the deformation process, or facilitate the rotation of the gear blank 50 and platen tool 404 during the deformation process.

Not illustrated but understood by those skilled in the art, inner roll tool 406, outer roll tool 400 and/or platen tool 404 in FIG. 5B may include additional or alternative configurations substantially resembling additional or alternative features of gear member 10. As an example, shoulder 26 (shown in FIG. 1A) may be formed by configuring inner roll tool 406 or outer roll tool 400 to substantially resemble a mirror image of shoulder 26, such that as gear blank 50 is incrementally deformed, shoulder 26 would be formed into gear member 10.

Referring again to FIG. 5B, ejection of gear member 10 from cavity 408 of platen tool 404 after forming may occur by axially raising in the direction of arrow 428 and rotating inner roll tool 406 so as to eject gear member 10 from cavity 408 of platen tool 404 with a twisting motion complementing tooth profile 34 of gear teeth 20, minimizing distortion of net shaped gear teeth 20. This method of ejection by twisting gear member 10 as it is raised out of cavity 408 of platen tool 404 may be further facilitated by meshing of surface 420 of tool 406 with surface features, for example, dimples or knurls, which may be formed on inner diameter 28 or shoulder 24 of gear member 10.

In a seventh embodiment of incremental deformation, referring now to FIG. 6A, a gear member 10 is incrementally deformed by axially-radially roll forming. Gear blank 56 (see FIGS. 2B and 2C) is positioned on platen tool 504 prior to forming and may be fixed to or positioned on platen tool 504 by a method as previously described for the third embodiment, where holes or slots 510 may contain pins, dowels, bolts or other similar tool details (not shown). As shown in FIG. 6A, the gear member is formed by an outer roll tool 500 applying sufficient pressure locally on surface 52 of gear blank 56 (see FIGS. 2B and 2C), while moving radially in the direction of arrow 512 relative to an inner roll tool 502, and moving axially in the direction of arrow 530 relative to the axis of platen tool 504 and gear blank 56, to form a gear member 10.

An outer roll tool 500, which may also be known by those skilled in the art as an OD roll, main roll or king roll, has a profile 514 configured to substantially resemble a plurality of radially outwardly extending gear teeth 20 and transition surface 30 by providing a profile which includes features which are counterpart or conjugate to corresponding features of net shaped gear teeth profile 34 and transition surface 30. Outer roll tool 500 rotates axially 516 as it progresses radially in the direction of arrow 512 and progresses axially in the direction of arrow 530, applying pressure to incrementally deform gear blank 56, including compacting gear tooth profile portion 54 to produce net shaped gear tooth profile 34 and inner transition surface 30 of gear member 10. After deforming, net shaped gear tooth profile 34 and plurality of gear teeth 20 are characterized by an increased density ratio and localized improved mechanical properties, as described previously.

Referring to FIG. 6A, surface 508 of platen tool 504 is configured to substantially resemble a base surface 18 and outer transition surface 22. As outer roll tool 500 progresses axially in the direction of arrow 512, it incrementally applies pressure on gear blank 56 to deform it against surface 508 of platen tool 504, to produce net shaped base surface 18 and outer transition surface 22 of gear member 10.

In FIG. 6A, inner roll tool 502 rotates axially on an axis 522 which may be fixed radially or be configured to progress radially outward. In either circumstance, inner roll tool 502 maintains a position where an outer surface 518 of inner roll tool 502 remains in proximate contact with inner diameter 526 of platen tool 504. Outer surface 518 is configured to substantially resemble corresponding features of net shaped inner diameter 28 and shoulder 24. As outer roll tool 500 progresses radially in the direction of arrow 512 and/or axially in the direction of arrow 530 relative to inner roll tool 502, gear blank 56 is deformed against outer surface 518 of inner roll tool 502 to produce net shaped inner diameter 28 and shoulder 24. Inner roll tool 502 may also be known by those skilled in the art as an ID roll or idler roll. Inner roll tool 502 may also move axially in the direction of arrow 528 to incrementally apply pressure on gear blank 56 to deform blank 56 against surface 508 of platen tool 504, to facilitate forming a base surface 18, outer transition surface 22 and shoulder 24 of net shaped gear member 10.

In FIG. 6A, gear blank 56 and platen tool 504 rotate relative to the rotation of inner roll tool 502 and outer roll tool 500 such that gear blank 56 is incrementally deformed circumferentially to produce gear member 10. The rotational, axial and radial movements of inner roll tool 502 and outer roll tool 500 and the rotational movement of platen tool 504 and gear blank 56 may be synchronized as required to produce a plurality of radially outwardly extending gear teeth 20. Shoulder 24 and/or inner diameter 28 may also be formed to include surface features, such as dimples, knurls, grooves or indentations, by deforming the surface of shoulder 24 and/or inner diameter 28 against a surface 518 of inner roll tool 502 resembling the desired surface features. The dimples, knurls, grooves, indentations, or similar surface features may, for example, be required for function or assembly of finished gear member 10, affect the kinematics of the deformation process, or facilitate the rotation of the gear blank 56 and platen tool 504 during the deformation process.

Although not illustrated here, it would be understood by those skilled in the art that inner roll tool 502, outer roll tool 500 and/or platen tool 504 in FIG. 6A may include additional or alternative configurations substantially resembling additional or alternative features desirable in gear member 10. As an example, shoulder 26 (shown in FIG. 1A) may be formed by configuring inner roll tool 502 or platen tool 504 to resemble shoulder 26, such that as gear blank 56 is incrementally deformed, shoulder 26 would be formed into gear member 10. Similarly to the description provided for platen 304 in the third embodiment, surface 508 of platen 504 may be configured as a counterpart to corresponding features of base surface 18 and outer transition surface 22.

In an eighth embodiment of incremental deformation, and referring now to FIG. 6B, there is shown a gear member 10 formed by axially-radially roll forming. Gear blank 56 (see FIGS. 2B and 2C) is positioned on platen tool 504 prior to forming and may be fixed to or positioned on platen tool 504 by a method as previously described for the third embodiment. Platen tool 504 is configured as described for the seventh embodiment. As shown in FIG. 6B, the gear blank 56 is incrementally deformed by an outer roll tool 500, in a similar manner as described for outer roll tool 500 in the seventh embodiment, to produce gear member 10. During the process of incremental deformation, gear tooth profile portion 54 is compacted to provide net shaped gear tooth profile 34 and a plurality of gear teeth 20 with a localized increased density ratio and localized improved mechanical properties.

An inner roll tool 506 provides an outer surface 520 configured to substantially resemble corresponding features of inner surface 16, including, for example, net shaped inner diameter 28 and shoulder 24 of gear member 10. Outer surface 520 is also configured to be coaxial with inner diameter 526 of platen tool 504. As shown in FIG. 6B, inner roll tool 506 rotates axially on an axis 532 which is coincident with axis 524 of platen tool 504 such that inner roll tool 506 maintains a position where an outer surface 520 of inner roll tool 506 remains in proximate contact with the inner diameter 526 of platen tool 504. As outer roll tool 500 progresses radially in the direction of arrow 512 and axially in the direction of arrow 530 relative to inner roll tool 506, gear blank 56 is deformed against outer surface 520 of inner roll tool 506 to produce net shaped inner diameter 28 and shoulder 24 of gear member 10. Inner roll tool 506 may also be configured to progress in axial direction 528 to apply pressure to facilitate incremental deformation of gear blank 56 against surface 508 of platen tool 504 and an outer surface 520 of inner roll tool 506. Inner roll tool 506 may also be known by those skilled in the art as an ID roll, idler roll or mandrel.

In FIG. 6B, gear blank 56 and platen tool 504 rotate relative to the rotation of inner roll tool 506 and outer roll tool 500 such that gear blank 56 is incrementally deformed circumferentially to produce gear member 10. The rotational, axial and radial movements of inner roll tool 506 and outer roll tool 500 and the rotational movement of platen tool 504 and gear blank 56 may be synchronized as required to produce a plurality of radially outwardly extending gear teeth 20. Shoulder 24 and/or inner diameter 28 may also be formed to include surface features, such as dimples, knurls, grooves or indentations, by deforming the surface of shoulder 24 and/or inner diameter 28 against a surface 520 of inner roll tool 506 substantially resembling the desired surface features. The dimples, knurls, grooves, indentations, or similar surface features may, for example, be required for function or assembly of finished gear member 10, affect the kinematics of the deformation process, or facilitate the rotation of the gear blank 56 and platen tool 504 during the deformation process.

Although not illustrated here, it would be understood by those skilled in the art that inner roll tool 506, outer roll tool 500 and/or platen tool 504 in FIG. 6B may include additional or alternative configurations substantially resembling additional or alternative features desirable in gear member 10. As an example, shoulder 26 (shown in FIG. 1A) may be formed by configuring inner roll tool 506 or platen tool 504 to substantially resemble shoulder 26, such that as gear blank 56 is incrementally deformed, shoulder 26 would be formed in gear member 10. As discussed for the previous embodiment, surface 508 of platen 504 may be configured as a counterpart to corresponding features of base surface 18 and outer transition surface 22.

After incrementally deforming blank 50, 56 into gear member 10, by a method of the embodiments described herein, gear tooth profile 34 of the plurality of radially outwardly extending gear teeth 20 may be finished by additional processing, such as heat treating, lapping, coining, rolling and burnishing. These additional processes may be employed after near net forming gear teeth 20 to enhance characteristics such as gear mesh, surface finish, hardness, toughness and density.

While the best modes for carrying out the invention have been described in detail, those familiar with the art to which this invention relates will recognize various alternative designs and embodiments for practicing the invention within the scope of the appended claims.

1. A method of forming a net shaped annular gear member having a base surface and a gear tooth surface, the gear tooth surface including a plurality of radially outwardly extending gear teeth, comprising:
providing an annular gear blank made of powder metal, wherein said annular gear blank has a first blank portion and a second blank portion;
wherein the second blank portion includes a surface including a plurality of radially outwardly extending gear teeth;
incrementally deforming the annular gear blank by applying sufficient pressure locally on said annular gear blank with at least two tools, wherein at least one of said at least two tools moves relative to said annular gear blank in at least one of an orbital, spiral, planetary, rotating, axial and radial motion to form the net shaped annular gear member.

2. The method of claim 1, further comprising:
at least one of heat treating, sintering and preheating at least a portion of said annular gear blank prior to incrementally deforming said annular gear blank.

3. The method of claim 1,
wherein said at least two tools are moveable; and
wherein the movement of said at least one of said at least two tools is synchronized with the movement of at least another of said at least two tools to form said net shaped annular gear member.

4. The method of claim 1 further comprising:
providing said annular gear blank wherein one of said first blank portion and said second blank portion of said annular gear blank is proportionally larger than net shaped size prior to incrementally deforming said annular gear blank to form said net shaped annular gear member.

5. The method of claim 1 further comprising:
wherein said at least one of said at least two tools substantially resembles said plurality of radially outwardly extending gear teeth of said net shaped annular gear member.

6. The method of claim 5 further comprising:
wherein said at least one of said at least two tools substantially resembling said plurality of radially outwardly extending gear teeth of said net shaped annular gear member is partially configured as at least one of a counterpart, mirror image and conjugate of at least a portion of said plurality of radially outwardly extending gear teeth of said net shaped annular gear member.

7. The method of claim 1,
providing said annular gear blank wherein said plurality of radially outwardly extending gear teeth is of a configuration defining one of a bevel gear and a hypoid gear.

8. The method of claim 1 further comprising:
incrementally deforming said annular gear blank to form said net shaped annular gear member including a configuration of surface features characterized by at least one of dimples, knurls, grooves, indentations, holes and slots;
wherein said at least one of said at least two tools substantially resembles said configuration of said surface features.

9. The method of claim 1 further comprising:
incrementally deforming said annular gear blank by repeatedly orbitally applying sufficient pressure locally to said one of said first blank portion and said second blank portion; and
wherein a first tool of said at least two tools is fixed axially and said first tool moves in at least one of an orbital, spiral or planetary motion.

10. The method of claim 1 further comprising:
incrementally deforming said annular gear blank by roll forming said annular gear blank between said at least two tools,
wherein said at least two tools are axially rotating;
wherein at least one of said at least two axially rotating tools moves radially to incrementally deform said annular gear blank.

11. The method of claim 10:
wherein said incrementally deforming said annular gear blank is performed by roll forming said annular gear blank between at least three tools.

12. The method of claim 10,
wherein at least one of said at least two axially rotating tools moves radially and axially.

13. The method of claim 10 further comprising:
synchronizing the movement of at least one of said at least two axially rotating tools with the movement of at least another of said at least two axially rotating tools to incrementally deform said plurality of radially outwardly extending gear teeth.

14. The method of claim 1 further comprising:
at least one of heat treating, lapping, coining, rolling, burnishing and knurling at least one of said gear tooth surface, said base surface and another surface of said net shaped annular gear member after forming said net shaped annular gear member.

15. A gear member having a plurality of radially outwardly extending gear teeth, formed by the following process:
providing a generally ring shaped blank having an outer surface, wherein said blank is made of powder metal;
incrementally deforming said generally ring shaped blank to form the gear member by applying sufficient pressure locally on said outer surface with at least two tools;
wherein at least one of said at least two tools substantially resembles said plurality of radially outwardly extending gear teeth; and
wherein at least one of said at least two tools moves relative to said generally ring shaped blank in at least one of an orbital, spiral, planetary, rotating, axial and radial motion to form the gear member.

16. A net shaped annular gear member comprising:
a generally annular gear body including a plurality of radially outwardly extending gear teeth configured by incremental deformation of a surface of said generally annular gear body with at least two tools;
wherein at least one of said at least two tools substantially resembles said plurality of radially outwardly extending gear teeth;
wherein said generally annular gear body is made of powder metal.

17. The net shaped annular gear member of claim 16,
wherein at least a portion of said generally annular gear body has been at least one of heat treated, sintered and preheated prior to said configuring by incremental deformation.

18. The net shaped annular gear member of claim 16,
wherein said surface of said generally annular gear body is configured by at least one of orbitally forging, radially roll forming and axially-radially roll forming.

19. The net shaped annular gear member of claim 16,
wherein a portion of said surface of said generally annular gear body is proportionally substantially the same as net formed size prior to being configured by said incremental deformation; and
wherein another portion of said surface of said generally annular gear body is proportionally larger than net formed size prior to being configured by said incremental deformation; so that when said another portion of said surface of said generally annular gear body is configured by incremental deformation to net formed size, said another portion of said surface of said net shaped annular gear member is characterized by at least one of a higher density, higher hardness, smaller grain size, preferred grain orientation, higher load carrying capacity, higher strength, higher toughness and higher wear resistance than said other portion of said net shaped annular gear member.

20. The net shaped annular gear member of claim 16,
wherein said plurality of radially outwardly extending gear teeth is of a configuration defining one of a bevel gear and a hypoid gear.
